(19) United States
(12) Patent Application Publication
(10) Pub. No.: US 2024/0063975 A1
(43) Pub. Date: Feb. 22, 2024

(54) DYNAMIC ADJUSTMENT METHODS FOR REFERENCE SIGNAL RECEPTION AND APPARATUS THEREOF

(71) Applicant: MEDIATEK INC., Hsinchu City (TW)

(72) Inventors: Hsien-Wen HU, Hsinchu City (TW); Qian-Zhi HUANG, Hsinchu City (TW); Ying-Hsuan SU, Hsinchu City (TW); Teng-Yuan CHANG, Hsinchu City (TW); Cheng-Yu TSAI, Hsinchu City (TW)

(21) Appl. No.: 18/366,921

(22) Filed: Aug. 8, 2023

Related U.S. Application Data
(60) Provisional application No. 63/371,773, filed on Aug. 18, 2022.

(51) Int. Cl. H04L 5/00; H04L 1/00; H04B 17/336; H04B 17/318

(52) U.S. Cl. CPC H04L 5/0051; H04L 1/0027; H04B 17/336; H04B 17/328

(57) ABSTRACT

A dynamic adjustment method for RS reception is provided. The dynamic adjustment method for RS reception includes the following steps. A processor of an apparatus may detect at least one channel condition to generate a detection result. Then, the processor may determine an RS reception scheduling based on the detection result. Then, the processor may perform an RS reception based on the RS reception scheduling to receive RSs from a network node.

### CROSS REFERENCE TO RELATED APPLICATIONS

This application claims the benefits of U.S. Provisional Application No. 63/371,773 filed on Aug. 18, 2022, the entirety of which is incorporated by reference herein.

### BACKGROUND OF THE INVENTION

### Field of the Invention

The invention generally relates to reference signal (RS) reception technology, and more particularly, to an RS reception technology in which the RS reception scheduling can be dynamically adjusted based on the channel conditions.

### Description of the Related Art

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is 5G New Radio (NR), which is a set of enhancements to the LTE mobile standard promulgated by the Third Generation Partnership Project (3GPP). It is designed to better support mobile broadband Internet access by improving spectral efficiency, reducing costs, and improving services.

In conventional technology, the UE may determine a fixed reference signal (RS) reception scheduling to receive the reference signals from the network node, i.e., the UE may receive the reference signals from the network node every fixed period. However, when current conditions (e.g., channel quality, channel traffic, etc.) are good enough, the fixed RS reception scheduling may lead to unnecessary power consumption to receive the RSs. In addition, when the current conditions (e.g., channel quality, channel traffic, etc.) are bad, the fixed RS reception scheduling may lead to the insufficient performance requirement.

Therefore, how to flexibly adjust the RS reception scheduling is a topic that is worthy of discussion.

### BRIEF SUMMARY OF THE INVENTION

A dynamic adjustment method for reference signal (RS) reception and an apparatus are provided to overcome the problems mentioned above.

An embodiment of the invention provides a dynamic adjustment method for RS reception. The dynamic adjustment method for RS reception comprises the following steps. A processor of an apparatus may detect at least one channel condition to generate a detection result. Then, the processor may determine an RS reception scheduling based on the detection result. Then, the processor may perform an RS reception based on the RS reception scheduling to receive RSs from a network node.

In some embodiments, in the dynamic adjustment method for RS reception, the processor may further determine whether to adjust the RS reception scheduling based on a new detection result, and perform the RS reception based on an adjusted RS reception scheduling. In some embodiments, in response to the new detection result being better than the previous detection result, the processor may decrease a frequency of receiving the RSs in the adjusted RS reception scheduling, and in response to the new detection result being worse than the previous detection result the processor may increase the frequency of receiving the RSs in the adjusted RS reception scheduling.

In some embodiments, in the dynamic adjustment method for RS reception, the RS reception scheduling may be associated with a sleep state or an active state. In an embodiment, in the dynamic adjustment method for RS reception, the processor may perform the RS reception in the sleep state and the active stat based on the RS reception scheduling. In another embodiment, the processor may perform the RS reception the active stat based on the RS reception scheduling.

In some embodiments, in the dynamic adjustment method for RS reception, the at least one channel condition may comprise a channel quality, a channel stability, a channel scenario and a channel performance requirement. In some embodiments, in the dynamic adjustment method for RS reception, the channel quality may comprise at least one of a signal-to-noise ratio (SNR), a reference signal received power (RSRP) and a received signal strength indication (RSSI), the channel stability may comprise at least one of a temperature and a mobility, the channel scenario may comprise at least one of a traffic and a throughput, and the channel performance requirement may comprise at least one of a block error (BLER), a cyclic redundancy check (CRC) result, a synchronization, a radio link monitoring (RLM) and a beam management (BM).

In some embodiments, in the dynamic adjustment method for RS reception, the processor may determine the RS reception scheduling based on the detection result and beam types. In some embodiments, in the dynamic adjustment method for RS reception, the number of times of receiving the RS associated with a primary beam is more than the number of times of receiving the RS associated with a secondary beam in the RS reception scheduling.

In some embodiments, in the dynamic adjustment method for RS reception, the RS reception scheduling may be associated with different types of RSs.

An embodiment of the invention provides an apparatus for dynamically adjusting reference signal (RS) reception. The apparatus comprises a transceiver and a processor. The processor is coupled to the transceiver. The processor is configured to detect at least one channel condition to generate a detection result. The processor is configured to determine an RS reception scheduling based on the detection result. In addition, the processor is configured to perform an RS reception based on the RS reception scheduling to receive RSs, via the transceiver, from a network node.

Other aspects and features of the invention will become apparent to those with ordinary skill in the art upon review of the following descriptions of specific embodiments of the dynamic adjustment method for reference signal (RS) reception and an apparatus.

### BRIEF DESCRIPTION OF THE DRAWINGS

The invention will become more fully understood by referring to the following detailed description with reference to the accompanying drawings, wherein:

FIG. 1 is a block diagram of a wireless communications system 100 according to an embodiment of the invention.

FIG. 2 is a schematic diagram illustrating a reference signal (RS) reception scheduling according to an embodiment of the invention.

FIG. 3 is a schematic diagram illustrating an RS reception scheduling according to another embodiment of the invention.

FIG. 4 is a dynamic adjustment method for RS reception according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

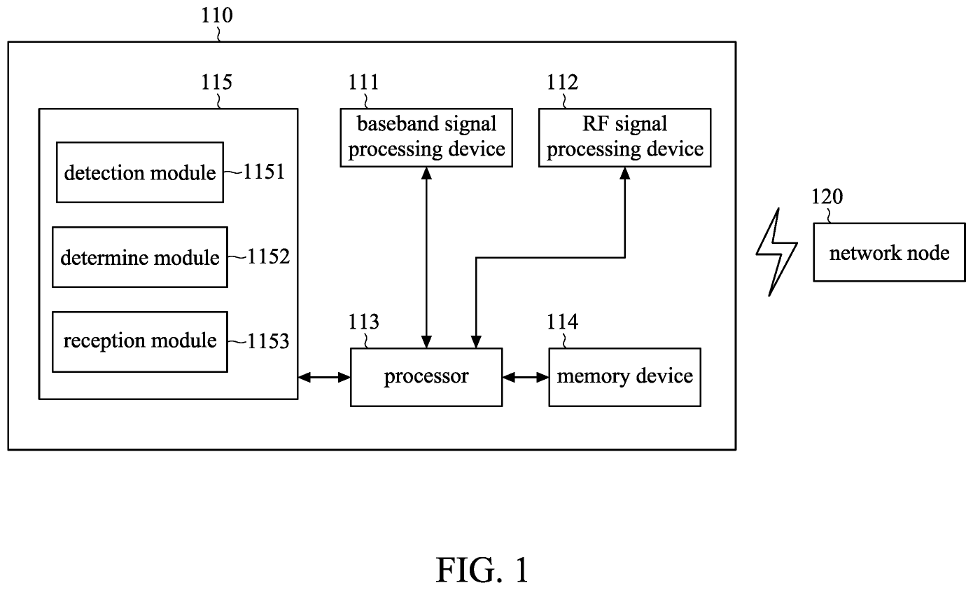

FIG. 1 is a block diagram of a wireless communications system 100 according to an embodiment of the invention. As shown in FIG. 1, the wireless communications system 100 may comprise user equipment (UE) 110 and a network node 120. It should be noted that in order to clarify the concept of the invention, FIG. 1 presents a simplified block diagram in which only the elements relevant to the invention are shown. However, the invention should not be limited to what is shown in FIG. 1.

In the embodiments of the invention, the UE 110 may be a smartphone, Personal Data Assistant (PDA), pager, laptop computer, desktop computer, wireless handset, or any computing device that includes a wireless communications interface.

In the embodiments, the network node 120 may be a base station, a gNodeB (gNB), a NodeB (NB) an eNodeB (eNB), an access point, an access terminal, but the invention should not be limited thereto. In the embodiments, the UE 110 may communicate with the network node 120 through the fourth generation (4G) communication technology, fifth generation (5G) communication technology (or 5G New Radio (NR) communication technology), or sixth generation (6G) communication technology, but the invention should not be limited thereto.

As shown in FIG. 1, the UE 110 may comprise at least a baseband signal processing device 111, a radio frequency (RF) signal processing device 112, a processor 113, a memory device 114, and function modules and circuits 115. The network node 120 may comprise similar devices as UE 110.

The RF signal processing device 112 may be a transceiver. The RF signal processing device 112 may comprise a plurality of antennas to receive or transmit RF signals. The RF signal processing device 112 may receive RF signals via the antennas and process the received RF signals to convert the received RF signals to baseband signals to be processed by the baseband signal processing device 111, or receive baseband signals from the baseband signal processing device 111 and convert the received baseband signals to RF signals to be transmitted to a peer communications apparatus. The RF signal processing device 112 may comprise a plurality of hardware elements to perform radio frequency conversion. For example, the RF signal processing device 112 may comprise a power amplifier, a mixer, analog-to-digital converter (ADC)/digital-to-analog converter (DAC), etc.

The baseband signal processing device 111 may further process the baseband signals to obtain information or data transmitted by the peer communications apparatus. The baseband signal processing device 111 may also comprise a plurality of hardware elements to perform baseband signal processing.

The processor 113 may control the operations of the baseband signal processing device 111, the RF signal processing device 112, the memory device 114 and the function modules and circuits 115. According to an embodiment of the invention, the processor 113 may also be arranged to execute the program codes of the software module(s) of the corresponding baseband signal processing device 111, the RF signal processing device 112 and the function modules and circuits 115. The program codes accompanied by specific data in a data structure may also be referred to as a processor logic unit or a stack instance when being executed. Therefore, the processor 113 may be regarded as being comprised of a plurality of processor logic units, each for executing one or more specific functions or tasks of the corresponding software modules.

The memory device 114 may store the software and firmware program codes, system data, user data, etc. of the UE 110. The memory device 114 may be a volatile memory such as a Random Access Memory (RAM); a non-volatile memory such as a flash memory or Read-Only Memory (ROM); a hard disk; or any combination thereof. The memory device 114 may stores a look-up table for adjusting the RS reception scheduling.

According to an embodiment of the invention, the RF signal processing device 112 and the baseband signal processing device 111 may collectively be regarded as a radio module capable of communicating with a wireless network to provide wireless communications services in compliance with a predetermined Radio Access Technology (RAT). Note that, in some embodiments of the invention, the UE 110 may be extended further to comprise more than one antenna and/or more than one radio module, and the invention should not be limited to what is shown in FIG. 1.

The function modules and circuits 115 may comprise a detection module 1151, a determine module 1152 and a reception module 1153. The processor 113 may execute different modules or circuits in the function modules and circuits 115 to perform embodiments of the present invention. In the embodiment of the invention, the detection module 1151 may detect at least one channel condition to generate a detection result. The determine module 1152 may determine a reference signal (RS) reception scheduling based on the detection result and determine whether to adjust the RS reception scheduling dynamically. The reception module 1153 may perform an RS reception based on the RS reception scheduling to receive RSs from the network node 120 through the RF signal processing device 112. The RSs may have different RS types, e.g. tracking reference signal (TRS) or synchronization signal block (SSB), but the invention should not be limited thereto.

In the embodiments of the invention, the UE 110 may detect at least one channel condition to generate a detection result. Then, the UE 110 may determine an RS reception scheduling based on the detection result. Specifically, the UE 110 may detect different channel conditions and consider the detected results of different channel conditions comprehensively to generate the detection result, and then the UE 110 may determine the RS reception scheduling based on the detection result.

In an example, after the UE 110 generate the detection result, the UE 110 may determine or find a suitable RS reception scheduling from a look-up table based on the detection result. The look-up table may pre-record a mapping or a linear relationship between the different detection results and different settings of the RS reception scheduling. That is, each detection result may be corresponded to a corresponding setting of the RS reception scheduling. The mapping may be pre-defined.

In an embodiment of the invention, the channel condition may comprise at least one of: a channel quality, a channel stability, a channel scenario and a channel performance requirement, but the invention should not be limited thereto. In an example, the channel condition may comprise the channel quality, the channel stability, the channel scenario and the channel performance requirement.

In an example, the channel quality may comprise at least one of a signal-to-noise ratio (SNR), a reference signal received power (RSRP) and a received signal strength indication (RSSI), but the invention should not be limited thereto.

In an example, the channel stability may comprise at least one of temperature (e.g., the temperature is stable or changes rapidly) and mobility (e.g., the UE 110 is in high-speed train. (HST) or in a stationary communication environment), but the invention should not be limited thereto.

In an example, the channel scenario may comprise at least one of traffic and throughput, but the invention should not be limited thereto.

In an example, the channel performance requirement may comprise at least one of block error (BLER), cyclic redundancy check (CRC) result, synchronization, radio link monitoring (RLM) and beam management (BM), but the invention should not be limited thereto.

After, the UE 110 determines the RS reception scheduling, the UE may perform an RS reception based on the determined RS reception scheduling to receive RSs from the network node 120. In addition, the UE 110 may continuously detect the current channel conditions to determine whether to adjust the RS reception scheduling based on a new detection result immediately. That is, the UE 110 can perform a real-time adjustment for the RS reception scheduling. If the UE 110 determines to adjust the RS reception scheduling, the UE 110 may perform the following RS reception based on an adjusted RS reception scheduling.

In an embodiment of the invention, if the new detection result is better than the previous detection result, the UE 110 may decrease a frequency of receiving the RSs in the adjusted RS reception scheduling to save power. That is, the current channel conditions are good enough (e.g., SNR=30 dB, the UE 110 is in the stationary communication environment, stable temperature and light traffic, but the invention should not be limited thereto), and therefore, the UE 110 does not need to receive RSs every period (e.g., every discontinuous reception (DRX) cycle or every RS cycle (e.g., TRS cycle or SSB cycle)). For example, the UE 110 may determine receive RSs every N periods (e.g., every N DRX cycles or every N RS cycles) in the RS reception scheduling, wherein N is greater than 1.

In another embodiment of the invention, if the new detection result is worse than the previous detection result, the UE 110 may increase a frequency of receiving the RSs in the adjusted RS reception scheduling to meet the performance requirement. That is, the current channel conditions are not good enough (e.g., SNR=−5 dB, the UE 110 is in the HST, the temperature changes rapidly and heavy traffic, but the invention should not be limited thereto), and therefore, the UE 110 may need to receive RSs every period (e.g., every DRX cycle or every RS cycle). For example, the UE 110 may determine receive RSs every period (e.g., every DRX cycle or every RS cycle) in the RS reception scheduling. In another example, if the new detection result is worse than the previous detection result, the UE 110 may also determine receive more than one group of RSs every DRX cycle.

According to an embodiment of the invention, the RS reception scheduling may be associated with a sleep state or an active state. When the RS reception scheduling is associated with the sleep state, the RS reception scheduling may be used to determine the RS reception before the DRX OnDuration. When the RS reception scheduling is associated with the active state, the RS reception scheduling may be used to determine the RS reception in the connected mode or in the discontinuous reception (DRX) OnDuration.

In an embodiment of the invention, in the sleep state, the UE 110 may determine to receive the RSs every DRX cycle or every N DRX cycles in the RS reception scheduling based on the detection result, wherein N is greater than 1. In addition, in the sleep state, the UE 110 may determine to receive more than one group of RSs every DRX cycle in the RS reception scheduling based on the detection result.

In an embodiment of the invention, in the active state, the UE 110 may determine to receive the RSs every RS cycle or every N RS cycles in the DRX OnDuration in the RS reception scheduling based on the detection result, wherein N is greater than 1.

In an embodiment of the invention, the UE 110 may determine to perform the RS reception in the sleep state and in the active state. In another embodiment of the invention, the UE 110 may determine to perform the RS reception only in the active state.

According to an embodiment of the invention, when the UE 110 determines the RS reception scheduling, the UE 110 may further consider the beam type (e.g., primary beam and secondary beam) corresponding to the RSs. In an example, the number of times of receiving the RS associated with the primary beam may be more than the number of times of receiving the RS(s) associated with the secondary beam(s) in the RS reception scheduling. In addition, the RS reception scheduling may be associated with different types of RSs.

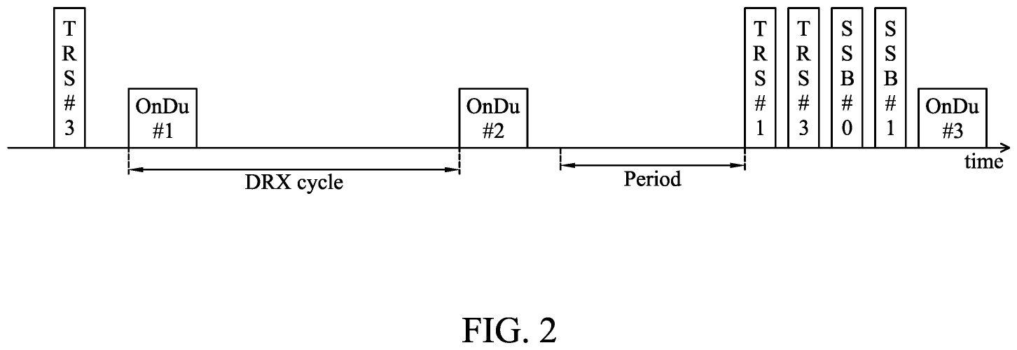

FIG. 2 is a schematic diagram illustrating an RS reception scheduling according to an embodiment of the invention. The RS reception scheduling of FIG. 2 is associated with the sleep state of the UE 110. As shown in FIG. 2, the reference signal TRS #3 may be associated with the primary beam, and the reference signals TRS #1, SSB #0 and SSB #1 may be associated with the secondary beams. When the UE 110 determines that the channel conditions are good enough, the UE 110 may determine not to receive all RSs every period (e.g., RS period) before each DRX OnDuration. In addition, because the reference signal TRS #3 is associated with the primary beam, the UE 110 may determine to receive the reference signal TRS #3 before the DRX OnDuration OnDu #1 and before the DRX OnDuration OnDu #3. The reference signals TRS #1, SSB #0 and SSB #1 associated with the secondary beams may be only received before the DRX OnDuration OnDu #3.

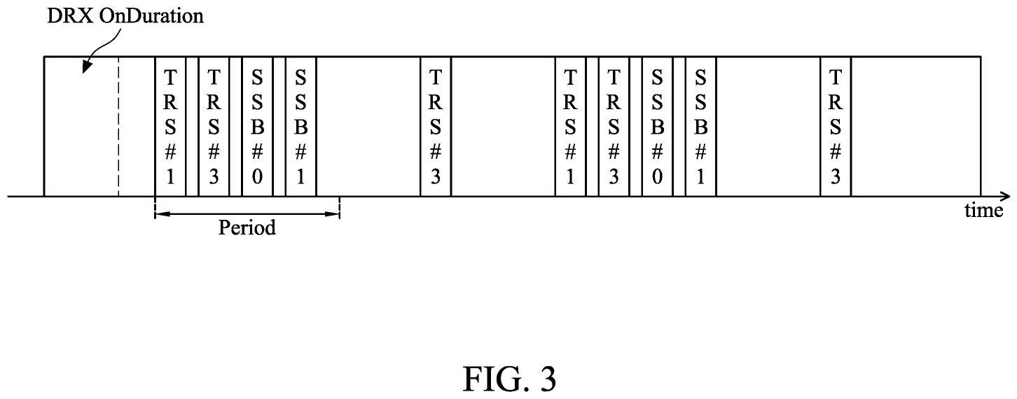

FIG. 3 is a schematic diagram illustrating an RS reception scheduling according to another embodiment of the invention. The RS reception scheduling of FIG. 3 is associated with the active state of the UE 110. As shown in FIG. 3, the reference signal TRS #3 may be associated with the primary beam, and the reference signals TRS #1, SSB #0 and SSB #1 may be associated with the secondary beams. When the UE 110 determines that the channel conditions are good enough, the UE 110 may determine not to receive all RSs every period in the DRX OnDuration. In addition, because the reference signal TRS #3 is associated with the primary beam, the number of times of receiving the reference signal TRS #3 may be more than the number of times of receiving the reference signals TRS #1, SSB #0 and SSB #1 associated with the secondary beams in the DRX OnDuration.

It should be noted that FIG. 2 and FIG. 3 are only used to illustrate the embodiments of the invention, but the invention should not be limited thereto.

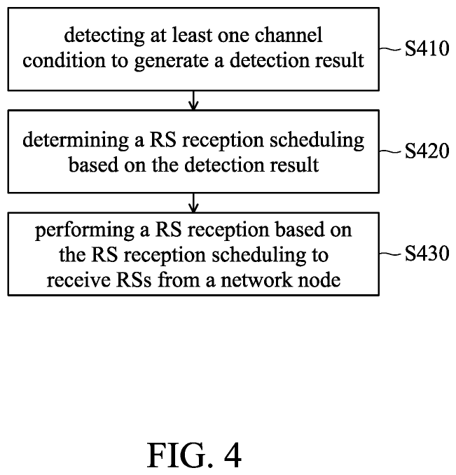

FIG. 4 is a flow chart illustrating a dynamic adjustment method for reference signal (RS) reception according to another embodiment of the invention. The dynamic adjustment method for RS reception can be applied to the wireless communication network 100. As shown in FIG. 4, in step S410, the UE 110 of the wireless communication network 100 may detect at least one channel condition to generate a detection result.

In step S420, the UE 110 may determine an RS reception scheduling based on the detection result.

In step S430, the UE 110 may perform an RS reception based on the RS reception scheduling to receive RSs from the network node 120 of the wireless communication network 100.

In an embodiment of the invention, in the dynamic adjustment method for RS reception, the UE 110 may further determine whether to adjust the RS reception scheduling based on a new detection result, and perform the RS reception based on an adjusted RS reception scheduling. In an embodiment, in response to the new detection result being better than the detection result, the UE 110 may decrease a frequency of receiving the RSs in the adjusted RS reception scheduling. In another embodiment, in response to the new detection result being worse than the detection result the UE 110 may increase the frequency of receiving the RSs in the adjusted RS reception scheduling.

In an embodiment of the invention, in the dynamic adjustment method for RS reception, the RS reception scheduling may be associated with a sleep state or an active state. In an embodiment, in the dynamic adjustment method for RS reception, the UE 110 may perform the RS reception in the sleep state and the active stat based on the RS reception scheduling. In another embodiment, the UE 110 may perform the RS reception the active stat based on the RS reception scheduling.

In an embodiment of the invention, in the dynamic adjustment method for RS reception, the at least one channel condition may comprise a channel quality, a channel stability, a channel scenario and a channel performance requirement. In an embodiment of the invention, in the dynamic adjustment method for RS reception, the channel quality may comprise at least one of a signal-to-noise ratio (SNR), a reference signal received power (RSRP) and a received signal strength indication (RSSI), the channel stability may comprise at least one of a temperature and a mobility, the channel scenario may comprise at least one of a traffic and a throughput, and the channel performance requirement may comprise at least one of a block error (BLER), a cyclic redundancy check (CRC) result, a synchronization, a radio link monitoring (RLM) and a beam management (BM).

In an embodiment of the invention, in the dynamic adjustment method for RS reception, the UE 110 may determine the RS reception scheduling based on the detection result and beam types. In an embodiment of the invention, in the dynamic adjustment method for RS reception, the number of times of receiving the RS associated with a primary beam is more than the number of times of receiving the RS associated with a secondary beam in the RS reception scheduling.

In an embodiment of the invention, in the dynamic adjustment method for RS reception, the RS reception scheduling may be associated with different types of RSs.

In the dynamic adjustment method for RS reception provided in the invention, the UE will be able to dynamically and flexibly adjust the RS reception scheduling based on the channel conditions.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A dynamic adjustment method for reference signal (RS) reception, comprising:
detecting, by a processor of an apparatus, at least one channel condition to generate a detection result;
determining, by the processor, an RS reception scheduling based on the detection result; and
performing, by the processor, an RS reception based on the RS reception scheduling to receive RSs from a network node.

2. The dynamic adjustment method for RS reception of claim 1, further comprising:
determining, by the processor, whether to adjust the RS reception scheduling based on a new detection result; and
performing, by the processor, the RS reception based on an adjusted RS reception scheduling.

3. The dynamic adjustment method for RS reception of claim 2, further comprising:
decreasing, by the processor, a frequency of receiving the RSs in the adjusted RS reception scheduling, in response to the new detection result being better than the detection result; and
increasing, by the processor, the frequency of receiving the RSs in the adjusted RS reception scheduling, in response to the new detection result being worse than the detection result.

4. The dynamic adjustment method for RS reception of claim 1, wherein the RS reception scheduling is associated with a sleep state or an active state.

5. The dynamic adjustment method for RS reception of claim 4, wherein the performing the RS reception further comprises:
performing, by the processor, the RS reception in the sleep state and the active state or in the active state based on the RS reception scheduling.

6. The dynamic adjustment method for RS reception of claim 1, wherein the at least one channel condition comprises a channel quality, a channel stability, a channel scenario and a channel performance requirement.

7. The dynamic adjustment method for RS reception of claim 1, wherein the channel quality comprises at least one of a signal-to-noise ratio (SNR), a reference signal received power (RSRP) and a received signal strength indication (RSSI), the channel stability comprises at least one of a temperature and a mobility, the channel scenario comprises at least one of a traffic and a throughput, and the channel performance requirement comprises at least one of a block error (BLER), a cyclic redundancy check (CRC) result, a synchronization, a radio link monitoring (RLM) and a beam management (BM).

8. The dynamic adjustment method for RS reception of claim 1, wherein the determining the RS reception scheduling further comprises:
determining, by the processor, the RS reception scheduling based on the detection result and beam types.

9. The dynamic adjustment method for RS reception of claim 8, wherein the number of times of receiving the RS associated with a primary beam is more than the number of times of receiving the RS associated with a secondary beam in the RS reception scheduling.

10. The dynamic adjustment method for RS reception of claim 1, wherein the RS reception scheduling is associated with different types of RSs.

11. An apparatus for dynamically adjusting reference signal (RS) reception, comprising:
a transceiver; and
a processor, coupled to the transceiver, and configured to:
detect at least one channel condition to generate a detection result;
determine an RS reception scheduling based on the detection result; and
perform an RS reception based on the RS reception scheduling to receive RSs, via the transceiver, from a network node.

12. The apparatus of claim 11, wherein the processor further determines whether to adjust the RS reception scheduling based on a new detection result, and performs the RS reception based on an adjusted RS reception scheduling.

13. The apparatus of claim 12, wherein in response to the new detection result being better than the detection result, the processor decreases a frequency of receiving the RSs in the adjusted RS reception scheduling, and in response to the new detection result being worse than the detection result, the processor increases the frequency of receiving the RSs in the adjusted RS reception scheduling.

14. The apparatus of claim 11, wherein the RS reception scheduling is associated with a sleep state or an active state.

15. The apparatus of claim 14, wherein the processor further performs the RS reception in the sleep state and the active state or in the active state based on the RS reception scheduling.

16. The apparatus claim 11, wherein the at least one channel condition comprises a channel quality, a channel stability, a channel scenario and a channel performance requirement.

17. The apparatus of claim 11, wherein the channel quality comprises at least one of a signal-to-noise ratio (SNR), a reference signal received power (RSRP) and a received signal strength indication (RSSI), the channel stability comprises at least one of a temperature and a mobility, the channel scenario comprises at least one of a traffic and a throughput, and the channel performance requirement comprises at least one of a block error (BLER), a cyclic redundancy check (CRC) result, a synchronization, a radio link monitoring (RLM) and a beam management (BM).

18. The apparatus of claim 11, wherein the processor further determines the RS reception scheduling based on the detection result and beam types.

19. The apparatus of claim 18, wherein the number of times of receiving the RS associated with a primary beam is more than the number of times of receiving the RS associated with a secondary beam in the RS reception scheduling.

20. The apparatus of claim 11, wherein the RS reception scheduling is associated with different types of RSs.
